(19) United States
(12) Patent Application Publication
(10) Pub. No.: US 2026/0136338 A1
(43) Pub. Date: May 14, 2026

(54) INTERFERENCE MEASUREMENT IN REVERSE SPECTRUM SHARING

(71) Applicant: QUALCOMM Incorporated, San Diego, CA (US)

(72) Inventors: Chiranjib SAHA, Lakeside, CA (US); Alberto RICO ALVARINO, San Diego, CA (US); Xiao Feng WANG, San Diego, CA (US); Harikumar KRISHNAMURTHY, San Diego, CA (US)

(21) Appl. No.: 18/946,210

(22) Filed: Nov. 13, 2024

(51) Int. Cl. H04W 72/0453; H04L 27/26

(52) U.S. Cl. CPC H04W 72/0453; H04L 27/261

(57) ABSTRACT

Certain aspects of the present disclosure provide techniques for interference measurement in a reverse spectrum sharing environment. An example method includes communicating via a first set of frequency resources allocated for uplink communications associated with a first cell; communicating via a second set of frequency resources allocated for downlink communications associated with the first cell; obtaining an indication of a measurement occasion associated with measurement of interference in the second set of frequency resources, wherein the measurement occasion is arranged in time relative to first signaling associated with a second cell; and monitoring for the interference during at least the measurement occasion.

### INTRODUCTION

### Field of the Disclosure

Aspects of the present disclosure relate to wireless communications, and more particularly, to techniques for interference measurement.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a first user equipment (UE). The method includes communicating via a first set of frequency resources allocated for uplink communications associated with a first cell; communicating via a second set of frequency resources allocated for downlink communications associated with the first cell; obtaining an indication of a measurement occasion associated with measurement of interference in the second set of frequency resources, wherein the measurement occasion is arranged in time relative to first signaling associated with a second cell; and monitoring for the interference during at least the measurement occasion.

Certain aspects provide a method for wireless communications by a first network node. The method includes communicating via a first set of frequency resources allocated for uplink communications associated with a first cell; communicating via a second set of frequency resources allocated for downlink communications associated with the first cell; and sending an indication of a measurement occasion associated with measurement of interference in the second set of frequency resources, wherein the measurement occasion is arranged in time relative to first signaling associated with a second cell.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example non-terrestrial network (NTN).

FIG. 6 depicts an example of an interference measurement in a wireless communications network.

FIG. 7 depicts an example scheme associated with measurement of interference based on a measurement occasion.

FIG. 8 depicts an example scheme for sounding reference signal detection associated with interference measurement.

FIG. 9 depicts a process flow for interference measurement.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for interference measurement in a reverse spectrum sharing environment.

Certain wireless communication systems (e.g., Evolved Universal Terrestrial Radio Access (E-UTRA) systems, 5G New Radio (NR) systems, and/or future wireless communication systems) may facilitate communications coverage via a non-terrestrial network (NTN), such as a spaceborne (e.g., satellite) and/or airborne (e.g., airship, balloon, etc.) platform that provides wireless connectivity to user equipment (UE). In certain cases, frequency division duplex (FDD) spectrum sharing with reverse pairing (hereinafter “reverse spectrum sharing”) may be used to allocate downlink and uplink frequency spectrum among network nodes (e.g., base stations), such as a first network node of an NTN and a second network node of a terrestrial network (TN). As an example, under reverse spectrum sharing, the first network node may use a first frequency band and a second frequency band for downlink and uplink communications, respectively. The second network node may use the second frequency band and the first frequency band for downlink and uplink communications, respectively. Accordingly, the frequency bands used by the second network node for downlink and uplink communications may be a reverse pairing with respect to the frequency bands used by the first network node.

Technical problems for reverse spectrum sharing may include, for example, effective interference measurement at a UE communicating with a network node, for example, associated with an NTN. In certain cases, a first UE communicating with a first network node in a reverse spectrum sharing environment may encounter cross-link interference from one or more second UEs (hereinafter “the second UE”). Cross-link interference may occur when a device (e.g., a UE or network node) is transmitting while another device is receiving in the same frequency band. For example, the second UE may transmit uplink signaling to a second network node in the same frequency band as the first UE uses to receive downlink signaling from the first network node.

In certain wireless communication systems (e.g., 5G NR systems), the first UE may be configured to measure the cross-link interference associated with the second UE based on sounding reference signal (SRS) measurements. As an example, the second UE may be configured to transmit a SRS, and the first UE may be configured to receive the SRS and measure the signal strength of the received SRS. The signal strength may be indicative of the cross-link interference encountered at the first UE, for example, from the second UE. Such an interference measurement configuration may rely on the first network node and the second network being synchronized in time. For example, the first UE may be able to rely on determining the time synchronization from the synchronization signaling transmitted by the first network node to receive the SRS from the second UE, which may be synchronized in time according to the synchronization signaling transmitted by the second network node. In certain cases, the interference measurement configuration may depend on the first network node and the second network using a time division duplex (TDD) mode for wireless communications.

However, in certain cases, the first network node and the second network node may not be time synchronized with each other, for example, where the first network node and the second network node may be in a NTN and a TN, respectively. The NTN and TN may not be time synchronized with each other, for example, due to certain complexities in enabling time synchronization, the NTN and TN being maintained by different network operators, and/or the like. In certain cases, the network nodes may communicate using a FDD mode (such as a subband FDD mode or in the reverse spectrum sharing configuration) or using different duplexing modes (e.g., FDD and TDD modes). Accordingly, in such cases, the first UE may not be able to measure the cross-link interference from the second UE(s) based on the interference measurement configuration described above without additional information, since the first UE and the second UE may not have a common time synchronization.

Aspects described herein may overcome the aforementioned technical problem(s), for example, by providing certain scheme(s) for interference measurement, such as in a reverse spectrum sharing environment. In certain aspects, a measurement occasion for interference measurement may be associated with separate synchronization signaling from a cell other than a serving cell with which a UE is in communication, where the synchronization signaling may be transmitted by or in a neighbor cell. “Serving cell” may refer to a cell in which a communication link is established between a UE and a network node, and “neighboring cell” or “neighbor cell” may refer to a cell having a coverage area adjacent to or overlapping with the coverage area of the serving cell. Such an association between the synchronization signaling and the measurement occasion may enable the UE to identify the time at which to receive an SRS transmitted by another UE for cross-link interference measurement, for example, in cases where the network nodes are not time synchronized and/or using an FDD mode for communications. As an example, the first UE may be in communication with the first network node, and the second UE node may be in communication with the second network node as described above. The first UE may be configured with the measurement occasion arranged in time relative to the synchronization signaling transmitted by the second network node. The first UE may determine the time synchronization based on the synchronization signaling transmitted by the second network node and re-tune to receive an SRS transmitted by the second UE in the measurement occasion. In certain aspects, the association between the synchronization signaling and the measurement occasion may be implicitly or explicitly conveyed to the first UE.

Certain techniques for interference measurement described herein may provide various beneficial technical effects and/or advantages. The techniques for interference measurement may enable improved wireless communications performance, such as reduced latencies, increased throughput, and/or the like. The reduced latencies and/or increased throughput may be attributable to the association between the synchronization signaling associated with a neighbor cell and the measurement occasion for cross-link interference measurement. The association between the synchronization signaling and the measurement occasion may enable a UE to determine the time at which to receive an SRS for cross-link interference measurement. Measurement of the cross-link interference at the UE may allow the UE and/or a network node to mitigate the effects of the cross-link interference, which may in turn enable reduced latencies and/or increased throughput. As an example, the UE may report the cross-link interference to a network node, which may adjust transmission parameters (e.g., a channel precoder) to mitigate the effects of the cross-link interference. In certain cases, the UE may adjust reception parameters (e.g., channel equalization) to mitigate the effects of the cross-link interference.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

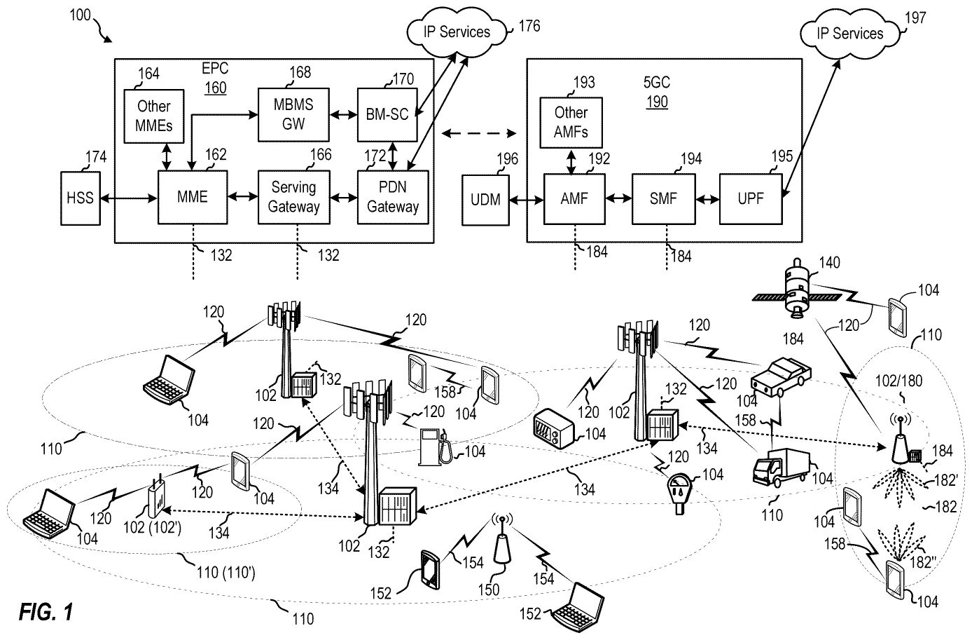

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

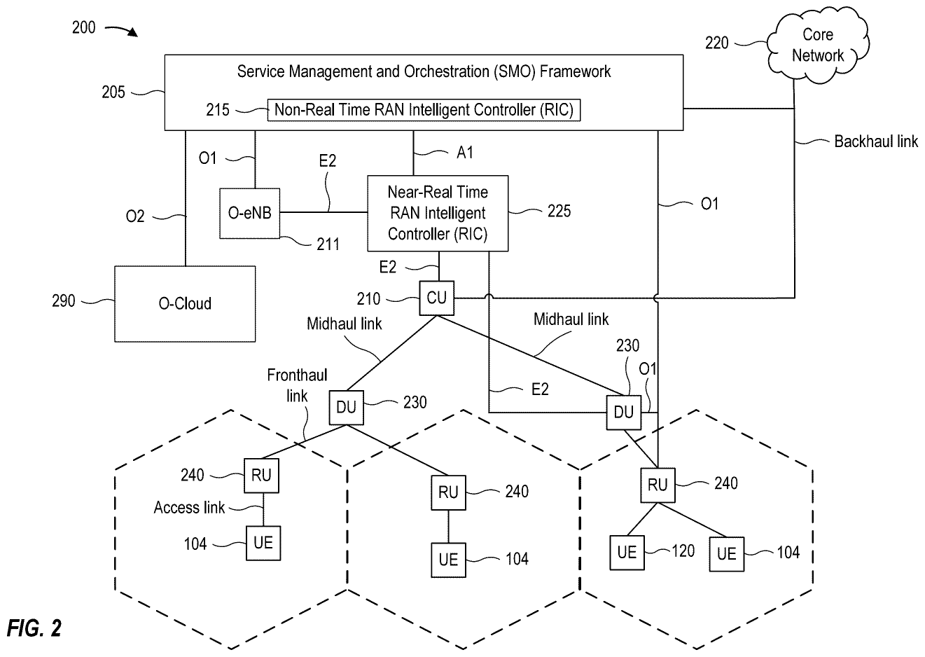

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1 ) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2 -2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

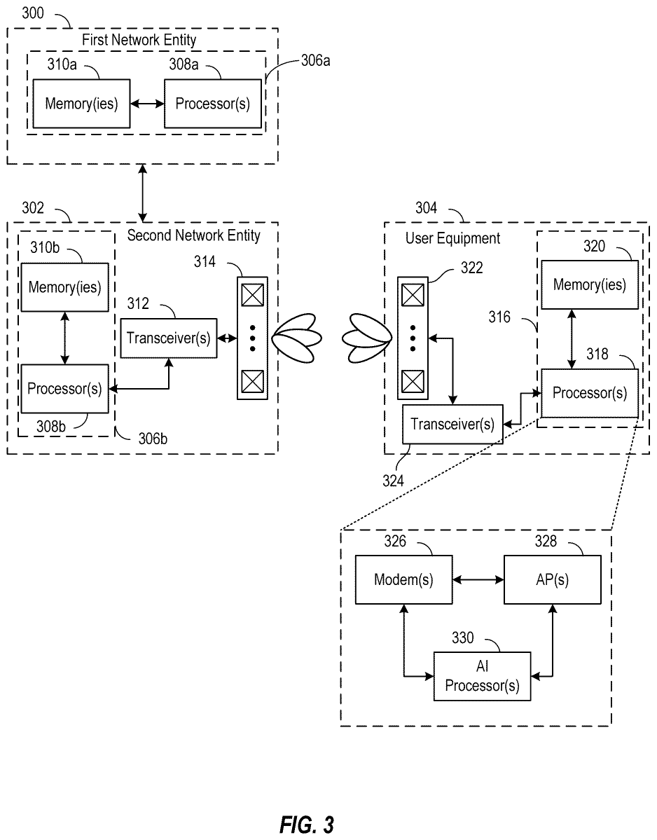

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

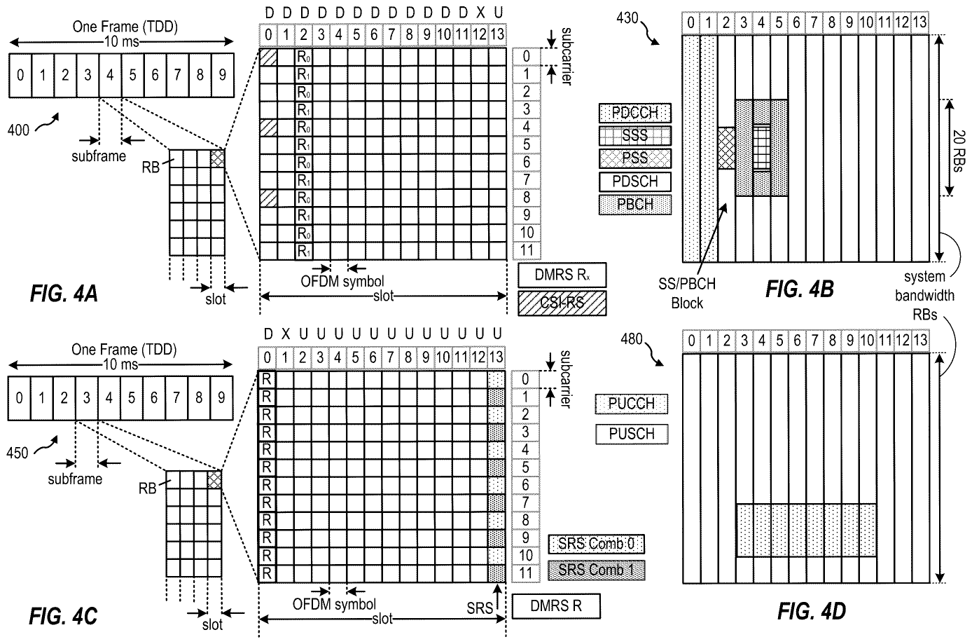

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Non-Terrestrial Network Communications

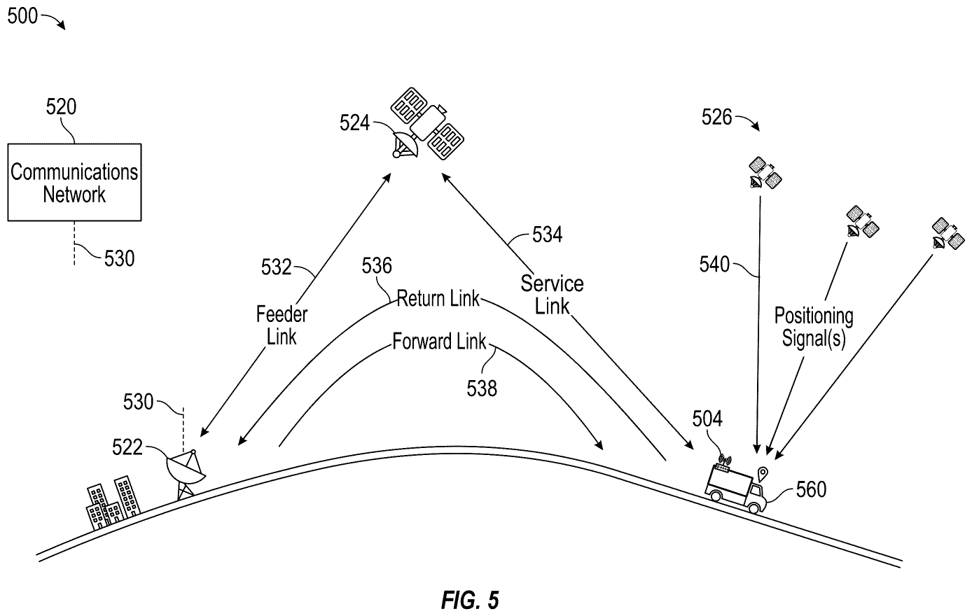

FIG. 5 depicts an example NTN 500. In this example, the NTN 500 includes a communications network 520 (e.g., the EPC 160 and/or the 5GC network 190 of FIG. 1), an NTN gateway 522, and an NTN payload 524. The NTN 500 may facilitate wireless communications with one or more UEs 504 (e.g., the UE 104 of FIG. 1). As an example, the UE 504 may be or include an IoT sensor and/or identification tag affixed to a vehicle 560. The NTN 500 may allow the UE 504 to be in a coverage area for wireless communications even where the vehicle 560 travels great distances, for example, across one or more countries, or is stationed in certain locations lacking a terrestrial communications network. Note that an IoT device is an example of a UE, and other UEs may be capable of NTN communications.

The NTN gateway 522 may communicate with the communications network 520 via one or more interfaces 530, such as backhaul links including NG interface(s) and/or S1 interface(s) between a RAN and a core network. The interface(s) 530 may include wired and/or wireless connections. The NTN gateway 522 may serve one or more NTN payloads 524. In certain aspects, the NTN gateway 522 may be co-located with or include a base station or a disaggregated network entity thereof.

The NTN payload 524 may be or include one or more airborne platforms (e.g., a drone or balloon) and/or one or more spaceborne platforms (e.g., the satellite 140 as depicted in FIG. 1). The NTN payload 524 may be served by one or more NTN gateways 522. In certain aspects, the NTN payload 524 may include any of various non-terrestrial network entities and/or platforms that provide radio access through Geosynchronous orbits (GSO), Non-Geosynchronous Orbit (NGSO) (which includes Low-Earth Orbit (LEO) and Medium Earth Orbit (MEO)), or High Altitude Platform Systems (HAPS).

The NTN payload 524 may transparently forward communications (e.g., the radio protocol) received from the UE 504 (via a service link 534) to the NTN gateway 522 (via a feeder link 532), and/or vice-versa. The NTN gateway 522 and the NTN payload 524 may communicate via a wireless communication link referred to as the feeder link 532, and the NTN payload 524 may communicate with the UE 504 via a wireless communication link referred to as the service link 534. In some cases, the transparent links between the NTN gateway 522 and the UE 504 may be referred to as a return link 536 for communications from the UE 504 to the NTN gateway 522 and as a forward link 538 for communications from the NTN gateway 522 to the UE 504. In certain aspects, for communications from the NTN gateway 522, the NTN payload 524 may change the carrier frequency used on the feeder link 532, before re-transmitting the communications on the service link 534, and/or vice versa (respectively on the feeder link).

The service link 534 may include an Earth-fixed service link, a quasi-Earth-fixed service link, and/or an Earth-moving service link. An Earth-fixed service link may be implemented by beam(s) continuously covering the same geographical area(s) all the time (e.g., the case of GSO satellites). A quasi-Earth-fixed service link may be provisioned by beam(s) covering one geographic area for a limited period and a different geographic area during another period (e.g., the case of NGSO satellites generating steerable beams). An Earth-moving service link may be provisioned by beam(s) with a coverage area that slides over the Earth surface (e.g., the case of NGSO satellites generating fixed or non-steerable beams).

In certain aspects, the UE 504 may be in communication with a global navigation satellite system (GNSS) 526. For example, the UE 504 may receive positioning signal(s) 540 from the GNSS 526, and the positioning signal(s) 540 may provide certain information for synchronizing (e.g., time and/or frequency synchronization) the service link 534. The UE 504 may obtain an indication of the location of the NTN payload 524 via system information from the NTN payload 524. In certain cases, the UE 504 may estimate a timing delay and/or Doppler effects associated with the service link 534 using the positioning signal(s) 540 and the location of the NTN payload 524.

### Aspects Related to Interference Measurement in Reverse Spectrum Sharing

Aspects of the present disclosure provide certain scheme(s) for interference measurement, such as in a reverse spectrum sharing environment. The scheme(s) for interference measurement may enable reduced latencies and/or increased throughput, for example, through certain interference mitigation techniques.

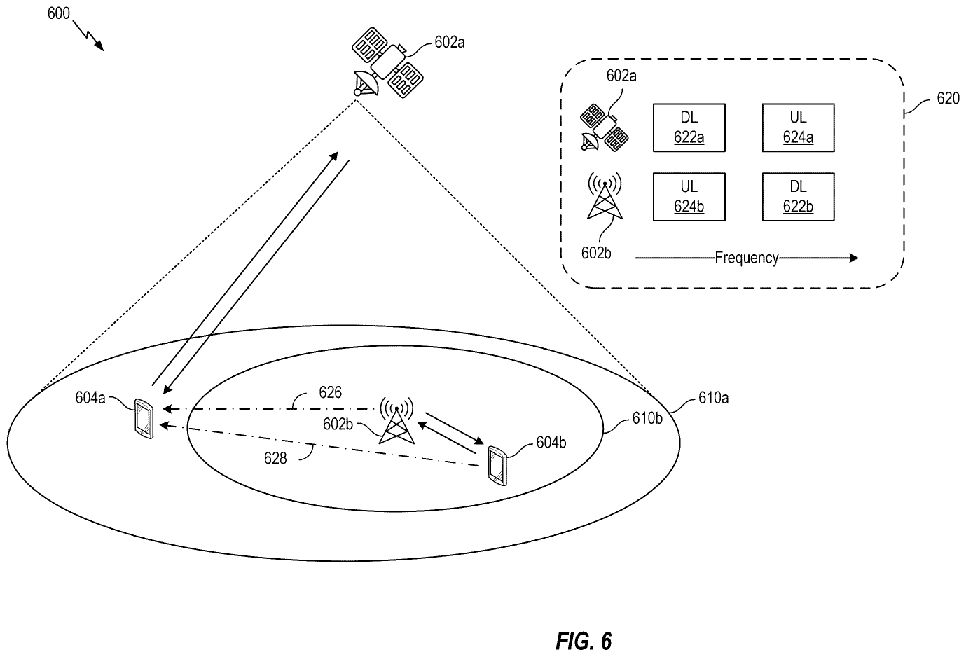

FIG. 6 depicts an example of an interference measurement in a wireless communications network 600 where reverse spectrum sharing may be employed, for example, between a NTN and a TN. In this example, the wireless communications network 600 may include a first network node 602a having a first coverage area 610a and a second network node 602b having a second coverage area 610b, which may overlap in space with the first coverage area 610a. In certain cases, the second coverage area 610b may be non-overlapping with and/or adjacent to the first coverage area 610a. The first network node 602a may be or include an NTN payload (e.g., the NTN payload 524 of FIG. 5), and the second network node 602b may be or include a network node associated with the TN, such as the first network entity 300 and/or the second network entity 302 of FIG. 3. In certain aspects, a first cell associated with the first network node 602a may form the first coverage area 610a, and a second cell associated with the second network node 602b may form the second coverage area 610b.

In certain aspects, the downlink and uplink frequency bands used by the first network node 602a and the second network node 602b may apply FDD spectrum sharing with reverse pairing (e.g., the reverse spectrum sharing 620). As an example, a first UE 604a may be located in the first coverage area 610a, and the first UE 604a may communicate FDD communications with the first network node 602a via a first downlink frequency band 622a and a first uplink frequency band 624a (for communication of downlink signaling and uplink signaling, respectively). The first uplink frequency band 624a may include a first set of frequency resources (for example, as described herein with respect to FIGS. 4A-4D), and the first downlink frequency band 622a may include a second set of frequency resources. The first set of frequency resources may be allocated for uplink communications associated with the first cell, and the second set of frequency resources may be allocated for downlink communications associated with the first cell. Accordingly, the first cell may be the serving cell of the first UE, and the second cell may be a neighbor cell of the first UE.

A second UE 604b may be located in the second coverage area 610b and communicate with the second network node 602b via a second downlink frequency band 622b and a second uplink frequency band 624b. The first downlink frequency band 622a may overlap with the second uplink frequency band 624b in the frequency domain, and the first uplink frequency band 624a may overlap with the second downlink frequency band 622b in the frequency domain. For example, the second downlink frequency band 622b may include the first set of frequency resources, and the second uplink frequency band 624b may include the second set of frequency resources. Accordingly, the first UE 604a may encounter interference (e.g., cross-link interference) in the first downlink frequency band 622a from uplink signaling transmitted by the second UE 604b in the second uplink frequency band 624b.

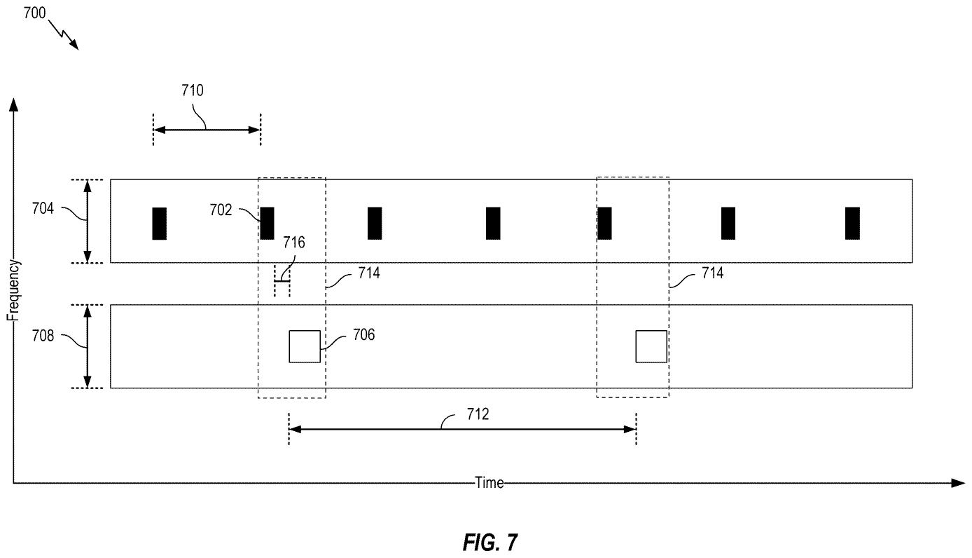

The first UE 604a may be configured to measure the interference from one or more UEs, such as the second UE 604b. As an example, the first UE 604a may obtain (for example, from the first network node 602a) a configuration (which may be or include one or more configurations) that indicates a measurement occasion (e.g., a measurement gap) associated with measurement of interference (for example, from the second UE 604b). The configuration may indicate that the measurement occasion is associated with first signaling 626 (e.g., synchronization signaling) communicated (e.g., transmitted) by or at the second network node 602b. The association between the measurement occasion and the first signaling 626 may indicate a time occurrence of the measurement occasion in accordance with a time reference derived from the first signaling 626, for example, as described herein with respect to FIG. 7. In certain cases, the association between the measurement occasion and the first signaling 626 may indicate that the measurement occasion is arranged in time relative to the first signaling as further described herein with respect to FIG. 7. In certain cases, the association between the first signaling 626 and the measurement occasion may indicate that the first signaling provides certain time and/or frequency synchronization information for reception of second signaling 628 from the second UE 604b. As an example, the association between the first signaling 626 and the measurement occasion may be indicated based on a cell identifier associated with the second cell, such as a physical cell identifier or a cell index of the second cell.

In certain cases, the configuration may indicate for the first UE 604a to perform inter-frequency synchronization and measurement in the measurement occasion. For example, during the measurement occasion, the first UE 604a may obtain, from the second network node 602b, the first signaling 626 in the first set of frequency resources and obtain, from the second UE 604b, the second signaling 628 in the second set of frequency resources. Accordingly, the first UE 604a may synchronize and/or measure using the first signaling 626 and second signaling 628 in the measurement occasion.

In certain cases, the configuration may indicate for the first UE 604a to perform synchronization outside of the measurement occasion via reception of the first signaling 626 and measurement of the second signaling 628 in the measurement occasion. As an example, outside of the measurement occasion, the first UE 604a may obtain, from the second network node 602b, the first signaling 626 in the first set of frequency resources, and during the measurement occasion, the first UE 604a may obtain, from the second UE 604b, the second signaling 628 in the second set of frequency resources.

In certain cases, the first signaling 626 may be or include synchronization signaling communicated in the first set of frequency resources (e.g., in the second downlink frequency band 622b and the first uplink frequency band 624a). The first signaling 626 may be associated with the second cell of the second network node 602b. As an example, the synchronization signaling may indicate or include a cell identifier (e.g., a physical cell identifier) associated with the second cell. The synchronization signaling may be or include one or more SSB transmissions output by or at the second network node 602b. Reception of the synchronization signaling at the first UE 604a may enable the first UE 604a to synchronize (for example, in terms of time and/or frequency) with the second network node 602b and/or the second UE 604b.

The measurement occasion may be or include a time period during which the first UE 604a may obtain at least the second signaling 628 transmitted by the second UE 604b, for example, as further described herein with respect to FIG. 7. The measurement occasion may be associated with measurement of one or more reference signals indicative or representative of cross-link interference. The second signaling 628 may be associated with the second UE 604b. For example, the second signaling 628 may be or include one or more SRSs communicated in the second set of frequency resources (for example, transmitted by or at the second UE 604b). In certain cases, the measurement occasion may be or include an SRS resource associated with measurement of interference (such as cross-link interference).

Measurement of interference in the second set of frequency resources may enable reduced latencies and/or increased throughput. For example, characterization of the interference in the second set of frequency resources encountered at the first UE 604a may allow the first UE 604a and/or the first network node 602a to mitigate the effects of the interference, for example, through a channel precoder (at the first network node 602a), channel decoder (at the first UE 604a), and/or channel equalization (at the first UE 604a).

In certain aspects, the configuration may indicate or include a cross-link interference sounding reference signal (CLI-SRS) resource configuration. The CLI-SRS resource configuration may indicate an SRS resource, which may include one or more time-frequency resources, in which an SRS is communicated. The SRS resource may be aperiodic, semi-persistent, and/or periodic. The SRS resource may have a subcarrier spacing and/or a frequency domain position, for example, in a bandwidth part of a carrier. The frequency domain position may be or include a frequency-domain starting position of the SRS. A bandwidth part may be a contiguous frequency range (e.g., resource blocks) of a channel bandwidth of a carrier. The carrier may be a frequency range of one or more operating bands specified for wireless communications, such as an operating band of FR1 and/or FR2. The SRS resource may occupy a frequency bandwidth in the bandwidth part or carrier, and the SRS resource may have a center frequency, for example, in the frequency bandwidth. In certain cases, the SRS resource may be arranged in an uplink bandwidth part associated with the second cell, and the configuration may indicate the frequency domain position of the SRS resource with respect to the uplink bandwidth part associated with the second cell. As an example, the CLI-SRS resource configuration may identify the uplink bandwidth part via a bandwidth part identifier and the corresponding cell to which the uplink bandwidth part belongs via a cell identifier or cell index.

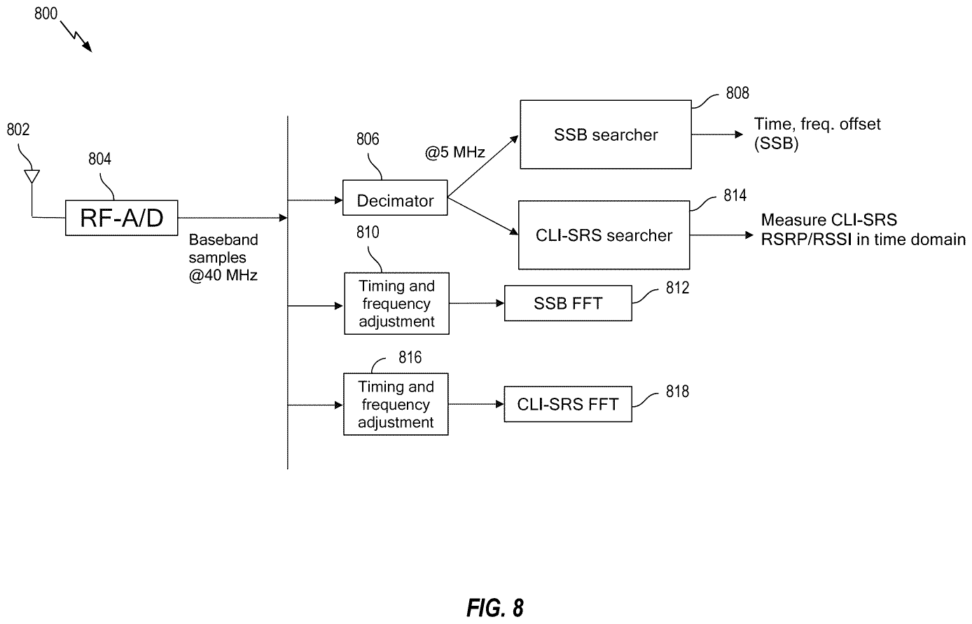

In certain aspects, the SRS transmitted by the second UE 604b may be configured for interference measurement in a reverse spectrum sharing environment. The SRS or a portion thereof may occupy a frequency bandwidth that enables the first UE 604a to perform SRS detection, for example, as further described herein with respect to FIG. 8. As an example, the SRS or a portion thereof may have or occupy the same frequency bandwidth as the first signaling 626, such as the frequency bandwidth of an SSB. In certain cases, the sequence of the SRS may be associated with measurement of cross-link interference between non-terrestrial communications and terrestrial communications. The sequence of the SRS may be specific to interference measurement in the reverse spectrum sharing environment. The sequence of the SRS may be configured to enable the first UE 604a to detect the SRS, for example, as further described herein with respect to FIG. 8.

The association between the first signaling 626 and the measurement occasion may be implicitly indicated to the first UE 604a. As an example, the first UE 604a may obtain the configuration via the first cell of the first network node 602a. In certain cases, the first UE 604a may be aware or determine that certain neighbor cell(s) (such as the second cell of the second network node) may not be time-synchronized with the first cell. For example, the first UE 604a may be aware or determine that the first cell and/or the first network node 602a is part of an NTN, and that the second cell and/or the second network node 602b is part of an TN (such as according to system information). Accordingly, the first UE 604a may assume that the measurement occasion (e.g., the CLI-SRS resource) is associated with the synchronization signaling of a neighbor cell (e.g., the second cell) instead of the serving cell (e.g., the first cell) via which the first UE 604a is in communication with the first network node 602a.

FIG. 7 depicts an example scheme 700 associated with measurement of interference based on a measurement occasion, for example, in a reverse spectrum sharing environment, such as described herein with respect to FIG. 6. In this example, first signaling 702 may be communicated in a first set of frequency resources 704, and second signaling 706 may be communicated in a second set of frequency resources 708. The first set of frequency resources 704 may be an example of the first uplink frequency band 624a and the second downlink frequency band 622b of FIG. 6. The second set of frequency resources 708 may be an example of the first downlink frequency band 622a and the second uplink frequency band 624b of FIG. 6. For example, a first UE (such as the first UE 604a of FIG. 6) may communicate FDD communications with a first network node (e.g., the first network node 602a of FIG. 6) via the first set of frequency resources 704 and the second set of frequency resources 708, as described herein with respect to FIG. 6.

The first signaling 702 may be or include synchronization signaling transmitted periodically by a second network node (e.g., the second network node 602b of FIG. 6). As an example, the first signaling 702 may be communicated with a first periodicity 710 (e.g., 20 milliseconds). The second signaling 706 may be or include an SRS transmitted by a second UE (e.g., the second UE 604b of FIG. 6). In certain cases, the second signaling 706 may be communicated periodically, for example, with a second periodicity 712 (e.g., 80 ms). In some other cases, the second signaling 706 may be communicated aperiodically (e.g., triggered). Note that the second signaling 706 may be communicated in a periodic, semi-persistent, and/or aperiodic SRS resource.

The first UE may be configured to measure cross-link interference in a measurement occasion 714. The measurement occasion 714 may be arranged in time relative to the first signaling 702. In certain cases, the beginning of the measurement occasion in time may coincide with the beginning of the first signaling 702. In certain cases, the measurement occasion 714 may be arranged in time to include an instance of the first signaling 702 (e.g., an SSB) and an instance of the second signaling 706 (e.g., an SRS transmission). As an example, the first UE may obtain the first signaling 702 in a first portion of the measurement occasion 714, and then, the first UE may obtain the second signaling 706 in a second portion of the measurement occasion 714. The first signaling 702 may enable the first UE to synchronize in time and/or frequency with the second network node and/or the second UE.

During the measurement occasion 714, the first UE may tune a transceiver (e.g., the transceiver 324 of FIG. 3) to receive the first signaling 702 in the first set of frequency resources 704, and the first UE may re-tune the transceiver to receive the second signaling 706 in the second set of frequency resources 708. A non-trivial amount of time may be used to re-tune the transceiver of the first UE from the first set of frequency resources 704 to the second set of frequency resources 708. Thus, the second signaling 706 may be offset in time from the first signaling 702, for example, by a time gap 716. The time gap 716 may be arranged between an end time of the first signaling 702 (e.g., a last symbol in time) and a start time of the second signaling 706 (e.g., a first symbol in time). The time gap 716 may have a duration that includes a timing advance associated with the second UE (e.g., the round trip time for communications between the second network node and the second UE) and a time period for the first UE to tune the transceiver between the first set of frequency resources 704 and the second set of frequency resources 708.

Note that the measurement occasion 714 depicted in FIG. 7 is an example of a measurement occasion to facilitate an understanding of the time-frequency relationship between the first signaling 702 and the second signaling 706 (such as the measurement occasion 714 being arranged in time relative to the first signaling 702). Aspects of the present disclosure may be applied to other suitable time-frequency arrangements of a measurement occasion associated with interference measurement, such as a measurement occasion that only includes one or more SRS resources arranged in time relative to the synchronization signaling associated with a neighbor cell.

FIG. 8 depicts an example scheme 800 for SRS detection associated with interference measurement. In certain cases, a first UE (e.g., the first UE 604a of FIG. 6) may receive and successfully detect synchronization signaling associated with a neighbor cell (e.g., the second cell of FIG. 6). As an example, the first UE may search for the synchronization signaling in a first set of frequency resources (such as the first set of frequency resources 704 of FIG. 7). The first UE may obtain signal(s) in the first set of frequency resources and convert the signal(s) to baseband samples using an antenna 802 coupled to a transceiver 804. The baseband samples may be digitized at a certain sampling rate (e.g., 40 MHz). The first UE may downsample the samples, for example, using a decimator 806 (e.g., to a sampling rate of 5 MHz). The first UE may identify an SSB in the time domain using an SSB searcher 808 (such as through spectrogram scanning for the SSB). The SSB searcher 808 may provide the time and frequency location of the SSB, for example, in terms a time and/or frequency offset. The first UE may apply a timing and/or frequency adjustment on the baseband samples, and the first UE may perform a fast Fourier transform (FFT) 812 to demodulate the baseband signal of the SSB in the samples. Based on the FFT of the samples, the first UE may derive time and/or frequency synchronization information to receive communications associated with the second cell (such as an SRS transmitted by the second UE). The first UE may use the time and/or frequency synchronization information to receive the SRS transmitted by the second UE in the second set of frequency resources (such as the second set of frequency resources 708 of FIG. 7). The first UE may retune to the second set of frequency resources, and the first UE may measure the SRS in the frequency domain, for example, to determine a received signal strength indicator (RSSI) and/or a reference signal received power (RSRP) associated with the SRS. In certain cases, the first UE may apply wideband processing to determine the RSSI and/or RSRP associated with the SRS.

In certain cases, the first UE may not receive or successfully detect the synchronization signaling associated with a neighbor cell (e.g., the second cell of FIG. 6). Accordingly, the first UE may search for the SRS without synchronization information derived from the synchronization signaling of the neighbor cell. The first UE may monitor for the SRS in the second set of frequency resources (such as the second set of frequency resources 708 of FIG. 7). The first UE may obtain signal(s) in the second set of frequency resources and covert the signals to baseband samples using the antenna 802 and the transceiver 804. The first UE may downsample the baseband samples, for example, using the decimator 806.

The first UE may search for a pattern of an SRS in the time domain using a CLI-SRS searcher 814. In certain cases, the first UE may search for the pattern of the SRS in sub-bands of the second set of frequency resources (e.g., a narrowband search with respect to the frequency bandwidth of the second set of frequency resources). A sequence of the SRS may form the pattern of the SRS in a time-frequency resource grid, for example, as described herein with respect to FIGS. 4A-4D. As an example, the sequence of the SRS may occupy a narrow bandwidth (such as the same bandwidth as an SSB), and the sequence may be configured to enable detection without synchronization information conveyed via synchronization signaling, such as the SSB of a neighbor cell. In certain cases, the first UE may search for the pattern of the SRS through a spectrogram scanning of the downsampled samples. The first UE may determine a measurement associated with the signal based on the signal and a pattern associated with the SRS. The first UE may determine the measurement based on a comparison of the received signal and the pattern of the signal in the time domain. The measurement may be or include the RSSI and/or RSRP associated with the SRS.

In certain aspects, the first UE may derive time and/or frequency synchronization information based on the SRS detected in the second set of frequency resources. The first UE may apply a timing and/or frequency adjustment 816 on the baseband samples, and the first UE may perform a fast Fourier transform (FFT) 818 to demodulate the baseband signal of the SRS in the samples. The first UE may measure the SRS in the frequency domain, for example, to determine the RSSI and/or RSRP associated with the SRS. Accordingly, the first UE may apply a narrowband search to identify the SRS in the second set of frequency resources and measure the RSSI and/or RSRP associated with the SRS.

Note that reverse spectrum sharing between an NTN and TN is an example scenario in which the techniques for interference measurement described herein may be applied. Aspects of the present disclosure associated with interference or SRS measurement may be applied to other suitable scenarios, such as reverse spectrum sharing between network nodes of a TN, a neighbor cell not being time synchronized with a serving cell, and/or a neighbor cell and serving cell communicating via different modes, such as FDD and TDD modes.

### Example Signaling Related to Interference Measurement

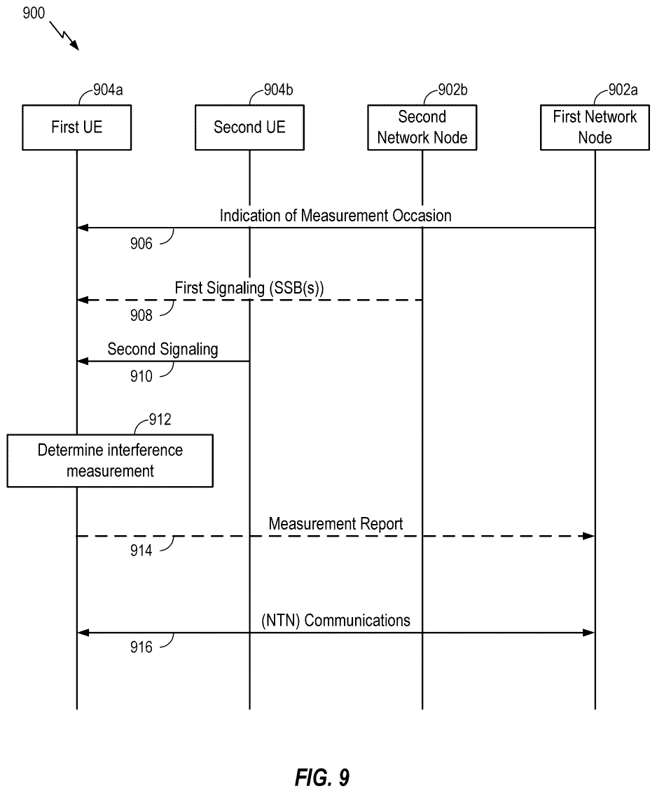

FIG. 9 depicts a process flow 900 for interference measurement in a network including a first network node 902a, a second network node 902b, a first UE 904a, and a second UE 904b. In some aspects, the network node 902a, 902b may be an example of the BS 102 depicted and described with respect to FIG. 1, the first network entity 300 or the second network entity 302 depicted and described with respect to FIG. 3, or a disaggregated base station depicted and described with respect to FIG. 2. In certain aspects, the first network node 902a may be an example of an NTN payload (e.g., the NTN payload 524 of FIG. 5), and the second network node 902b may be an example of a network node associated with a TN. Similarly, the UE 904a, 904b may be an example of UE 104 depicted and described with respect to FIG. 1 or the UE 304 depicted and described with respect to FIG. 3. However, in other aspects, the UE 904a, 904b may be another type of wireless communications device, and the network node 902a, 902b may be another type of network entity or network node, such as those described herein. Note that any operations or signaling illustrated with dashed lines may indicate that that operation or signaling is an optional or alternative example.

In this example, the first UE 904a may be located in a first coverage area of the first network node 902a, and the second UE 904b may be located in a second coverage area of the second network node 902b, for example, as described herein with respect to FIG. 6. A first cell associated with the first network node 902a may form the first coverage area, and a second cell associated with the second network node 902b may form the second coverage area.

At 906, the first UE 904a obtains, from the first network node 902a, an indication of a measurement occasion (e.g., measurement occasion 714) associated with measurement of interference, for example as described herein with respect to FIGS. 6 and 7. In certain cases, the indication of the measurement occasion may be conveyed via one or more configurations, such as a CLI-SRS resource configuration, as described herein with respect to FIG. 6. As an example, the indication of the measurement occasion may include information associated with an SRS resource, such as time-frequency resource(s) in which an SRS is communicated. The measurement occasion may be periodic, semi-persistent, and/or aperiodic. The indication of the measurement occasion may include an association between the measurement occasion and first signaling associated with the second cell of the second network node 902b, for example, as described herein with respect to FIG. 6. The indication of the measurement occasion may be communicated via RRC signaling, MAC signaling, DCI, system information, assistance information (e.g., CLI measurement assistance information), and/or the like.

At 908, the first UE 904a optionally obtains, from the first network node 902a, first signaling associated with a second cell. The first signaling may be or include synchronization signaling, such as one or more SSB transmissions. The first signaling may be communicated in a first set of frequency resources, for example, as described herein with respect to FIGS. 6 and 7. The first UE 904a may derive, from the first signaling, time and/or frequency synchronization information associated with the second cell, for example, as described herein with respect to FIGS. 6-8. The time and/or frequency synchronization information may enable the first UE 904a to determine the time and/or frequency at which to receive second signaling.

At 910, the first UE 904a monitors for interference during at least the measurement occasion. As an example, the first UE 904a obtains, from the second UE 904b, second signaling in the measurement occasion. The second signaling may include an SRS or the like. The second signaling may be communicated in a second set of frequency resources, for example, as described herein with respect to FIGS. 6 and 7.

At 912, the first UE 904a determines an interference measurement associated with the second set of frequency resources. As an example, the first UE 904a may determine a received signal strength (e.g., an RSSI and/or RSRP) and/or a received signal quality (e.g., a signal-to-noise ratio (SNR) and/or a signal-to-interference plus noise ratio (SINR)) associated with the second signaling.

At 914, the first UE 904a optionally sends, to the first network node 902a, a measurement report that includes an indication of the interference in the second set of frequency resources. The indication of the interference may include a received signal quality associated with the second signaling (e.g., the received SRS) or a received signal strength associated with the second signaling. The measurement report may enable the first network node 902a to adjust communications with the first UE 904a, such as frequency allocation, transmit power, modulation and coding scheme (MCS), coding rate, and/or the like.

At 916, the first UE 904a communicates with the first network node 902a. As an example, the first UE 904a may communicate FDD communications with the first network node 902a, as described herein with respect to FIG. 6. The first UE 904a may communicate via the first set of frequency resources allocated for uplink communications associated with the first cell, and the first UE 904a may communicate via the second set of frequency resources allocated for downlink communications associated with the first cell. For example, the first UE 904a may send, to the first network node 902a, uplink signaling via the first set of frequency resources, and the first UE 904a may obtain, from the first network node 902a, downlink signaling via the second set of frequency resources. In certain cases, the first UE 904a and the first network node 902a may communicate with each other via NTN communications, for example, as described herein with respect to FIGS. 5 and 6.

Measurement of interference in the second set of frequency resources may enable reduced latencies and/or increased throughput for communications between the first UE 904a and the first network node 902a. For example, characterization of the interference in the second set of frequency resources encountered at the first UE 904a may allow the first UE 904a and/or the first network node 902a to mitigate the effects of the interference. In certain cases, the first UE 904a may communicate with the first network node 902a based on the interference measurement(s) determined at 912. For example, the first UE 904a may adjust a channel decoder and/or channel equalization for downlink communications with the first network node 902a based on the interference measurement(s). In certain cases, the first network node 902a may communicate with the first UE 904a based on the measurement report obtained at 914. As an example, the first network node 902a may adjust a channel precoder for downlink communications with the first UE 904a based on the interference indicated in the measurement report.

Note that the process flow illustrated in FIG. 9 is described herein to facilitate an understanding of interference measurement in reverse spectrum sharing, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of Interference Measurement in Reverse Spectrum Sharing

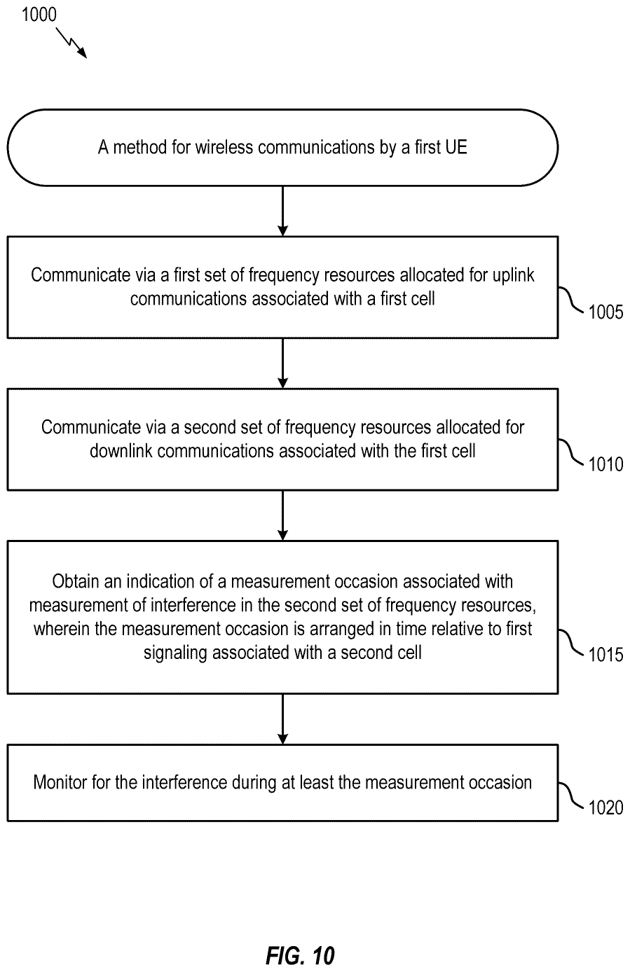

FIG. 10 shows a method 1000 for wireless communications by a first user equipment, such as UE 104 of FIG. 1 or UE 304 of FIG. 3.

Method 1000 begins at block 1005 with communicating via a first set of frequency resources allocated for uplink communications associated with a first cell, for example, as described herein with respect to FIGS. 5, 6, and 9.

Method 1000 then proceeds to block 1010 with communicating via a second set of frequency resources allocated for downlink communications associated with the first cell, for example, as described herein with respect to FIGS. 5, 6, and 9.

Method 1000 then proceeds to block 1015 with obtaining an indication of a measurement occasion associated with measurement of interference in the second set of frequency resources, wherein the measurement occasion is arranged in time relative to first signaling associated with a second cell, for example, as described herein with respect to FIGS. 6, 7, and 9.

Method 1000 then proceeds to block 1020 with monitoring for the interference during at least the measurement occasion, for example, as described herein with respect to FIGS. 6-9.

In certain aspects, the first signaling includes synchronization signaling in the first set of frequency resources; and the interference includes second signaling associated with a second UE.

In certain aspects, block 1005 includes communicating with a first network node via the first set of frequency resources; block 1010 includes communicating with the first network node via the second set of frequency resources; the first signaling includes the synchronization signaling communicated via a second network node; and the second signaling includes a sounding reference signal transmitted by the second UE.

In certain aspects, at least a first portion of the measurement occasion is offset in time from the first signaling, and the first portion of the measurement occasion includes a first time period during which second signaling is transmitted by a second UE.

In certain aspects, at least a second portion of the measurement occasion includes a second time period during which the first signaling is communicated; and the method 1000 further comprises refraining from communicating with the first cell during the at least the second portion of the measurement occasion.

In certain aspects, block 1015 includes obtaining the first signaling that indicates a portion of the measurement occasion is offset in time from the first signaling.

In certain aspects, method 1000 further includes obtaining a configuration that includes the indication of the measurement occasion, wherein the configuration further includes an indication that a sounding reference signal resource is associated with measurement of interference.

In certain aspects, the configuration further includes an indication of one or more of: a bandwidth part in which the sounding reference signal resource is arranged, a subcarrier spacing associated with the sounding reference signal resource, or a center frequency associated with the sounding reference signal resource.

In certain aspects, block 1020 includes monitoring for a sounding reference signal during at least the measurement occasion.

In certain aspects, monitoring for the sounding reference signal comprises: obtaining a signal in the second set of frequency resources; and determining a measurement associated with the signal based on the signal and a pattern associated with the sounding reference signal.

In certain aspects, a time gap is arranged between the first signaling and at least a portion of the measurement occasion during which the sounding reference signal is communicated, wherein the time gap includes a first duration associated with retuning a transceiver and a second duration associated with a timing advance.

In certain aspects, the sounding reference signal occupies a same bandwidth as synchronization signaling.

In certain aspects, the sounding reference signal is formed based on a sequence associated with measurement of cross-link interference between non-terrestrial communications and terrestrial communications.

In certain aspects, the first cell is associated with a non-terrestrial network node; and the second cell is associated with a terrestrial network node.

In certain aspects, the interference includes cross-link interference between non-terrestrial communications and terrestrial communications.

In certain aspects, method 1000 further includes sending a measurement report that includes an indication of the interference in the second set of frequency resources, for example, as described herein with respect to FIG. 9.

In certain aspects, the indication of the interference includes one or more of a received signal quality associated with a sounding reference signal or a received signal strength associated with the sounding reference signal.

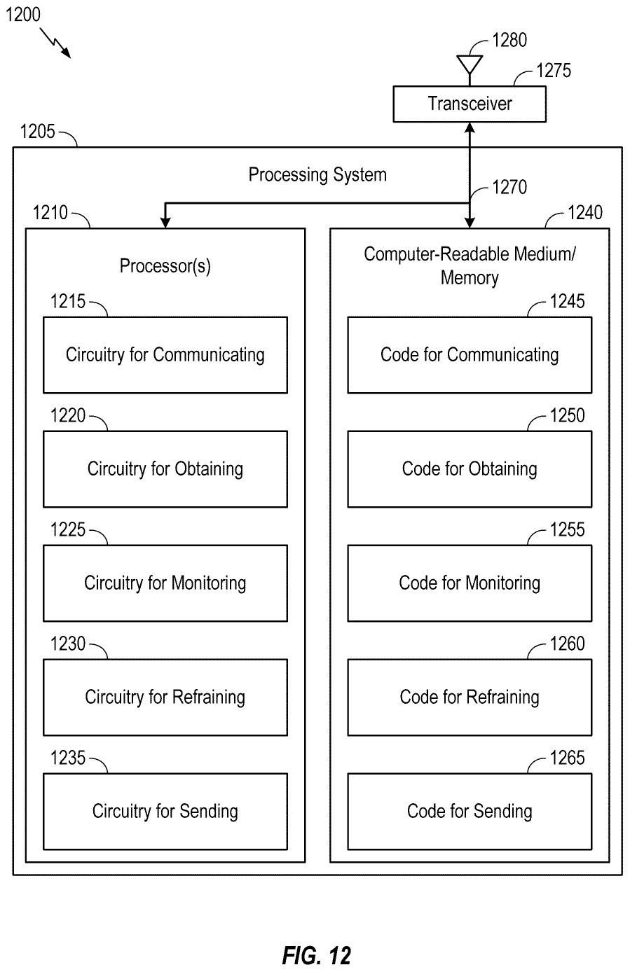

In some aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

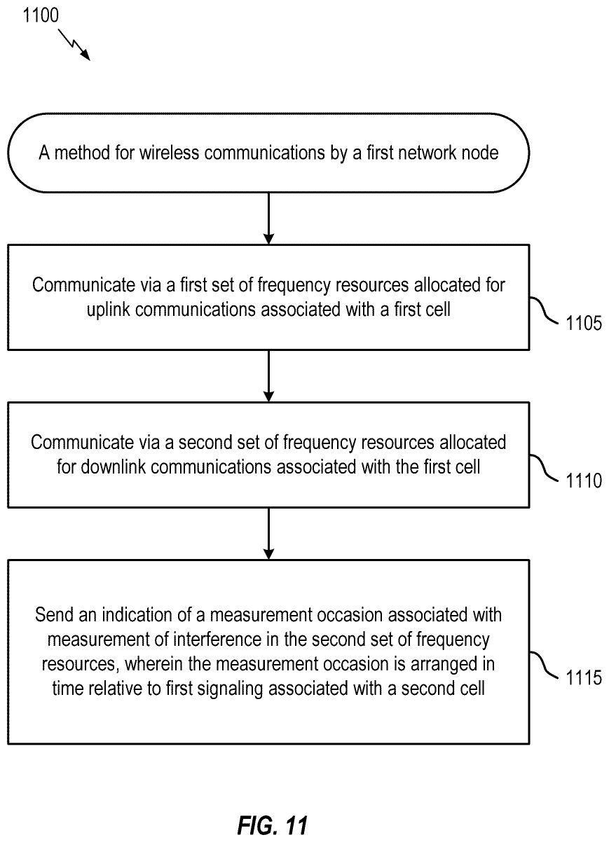

FIG. 11 shows a method 1100 for wireless communications by a first network node, such as BS 102 of FIG. 1, a first network entity 300 or second network entity 302 of FIG. 3, or a disaggregated base station as discussed with respect to FIG. 2.

Method 1100 begins at block 1105 with communicating via a first set of frequency resources allocated for uplink communications associated with a first cell, for example, as described herein with respect to FIGS. 5, 6, and 9.

Method 1100 then proceeds to block 1110 with communicating via a second set of frequency resources allocated for downlink communications associated with the first cell, for example, as described herein with respect to FIGS. 5, 6, and 9.

Method 1100 then proceeds to block 1115 with sending an indication of a measurement occasion associated with measurement of interference in the second set of frequency resources, wherein the measurement occasion is arranged in time relative to first signaling associated with a second cell, for example, as described herein with respect to FIGS. 6, 7, and 9.

In certain aspects, the first signaling includes synchronization signaling in the first set of frequency resources; and the interference includes second signaling associated with a second UE.

In certain aspects, block 1105 includes communicating with a first UE via the first set of frequency resources; block 1110 includes communicating with the first UE via the second set of frequency resources; the first signaling includes the synchronization signaling associated with a second network node; and the second signaling includes a sounding reference signal associated with the second UE.

In certain aspects, at least a first portion of the measurement occasion is offset in time from the first signaling, and the first portion of the measurement occasion includes a first time period during which second signaling is communicated.

In certain aspects, at least a second portion of the measurement occasion includes a second time period during which the first signaling is communicated; and the method 1100 further comprises refraining from communicating via the first cell during the at least the second portion of the measurement occasion.

In certain aspects, block 1115 includes sending the first signaling that indicates a portion of the measurement occasion is offset in time from the first signaling.

In certain aspects, method 1100 further includes sending a configuration that includes the indication of the measurement occasion, wherein the configuration further includes an indication that a sounding reference signal resource is associated with measurement of interference.

In certain aspects, the configuration further includes an indication of one or more of: a bandwidth part in which the sounding reference signal resource is arranged, a subcarrier spacing associated with the sounding reference signal resource, or a center frequency associated with the sounding reference signal resource.

In certain aspects, a time gap is arranged between the first signaling and at least a portion of the measurement occasion during which a sounding reference signal is communicated, wherein the time gap includes a first duration associated with retuning a transceiver and a second duration associated with a timing advance.

In certain aspects, the sounding reference signal occupies a same bandwidth as synchronization signaling.

In certain aspects, the sounding reference signal is based on a sequence associated with measurement of cross-link interference between non-terrestrial communications and terrestrial communications.

In certain aspects, the first cell is associated with a non-terrestrial network node; and the second cell is associated with a terrestrial network node.

In certain aspects, the interference includes cross-link interference between non-terrestrial communications and terrestrial communications.

In certain aspects, method 1100 further includes obtaining a measurement report that includes an indication of the interference in the second set of frequency resources, for example, as described herein with respect to FIG. 9.

In certain aspects, the indication of the interference includes one or more of a received signal quality associated with a sounding reference signal or a received signal strength associated with the sounding reference signal.

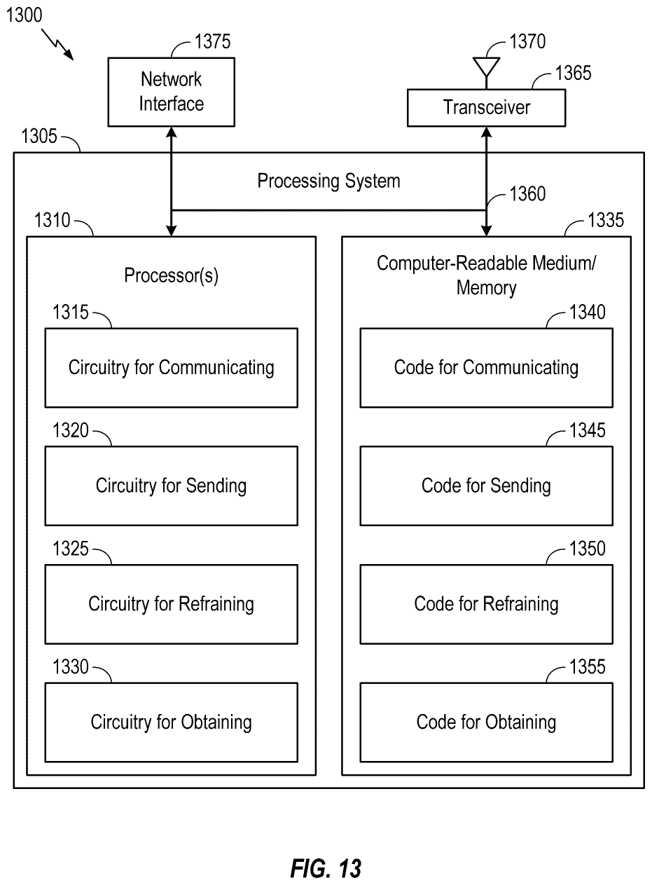

In some aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1275 (e.g., a transmitter and/or a receiver). The transceiver 1275 is configured to transmit and receive signals for the communications device 1200 via an antenna 1280, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1240. In various aspects, the one or more processors 1210 may be representative of the one or more processors 318 described with respect to FIG. 3. The one or more processors 1210 are coupled to a computer-readable medium/memory 1240 via a bus 1270. In some aspects, the computer-readable medium/memory 1240 may be representative of the one or more memories 320 described with respect to FIG. 3. The computer-readable medium/memory 1240 is a non-transitory computer-readable medium/memory. In certain aspects, the computer-readable medium/memory 1240 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1240 stores code (e.g., executable instructions), including code for communicating 1245, code for obtaining 1250, code for monitoring 1255, code for refraining 1260, and code for sending 1265. Processing of the code 1245-1265 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1240, including circuitry for communicating 1215, circuitry for obtaining 1220, circuitry for monitoring 1225, circuitry for refraining 1230, and circuitry for sending 1235. Processing with circuitry 1215-1235 may enable and cause the communications device 1200 to perform the method 1000 described with respect to FIG. 10, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1275 and/or antenna 1280 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1275 and/or antenna 1280 of the communications device 1200 in FIG. 12, and/or one or more processors 1210 of the communications device 1200 in FIG. 12. For example, means for monitoring and/or means for refraining of the method 1000 described with respect to FIG. 10, or any aspect related to it, may include the one or more transceivers 324, one or more antenna 322 and/or processing system 316 of the UE 304 illustrated in FIG. 3, transceiver 1275 and/or antenna 1280 of the communications device 1200 in FIG. 12, and/or one or more processors 1210 of the communications device 1200 in FIG. 12.

FIG. 13 depicts aspects of an example communications device configured for wireless communications. In some aspects, communications device 1300 is a network entity, such as BS 102 of FIG. 1, first network entity 300 or second network entity 302 of FIG. 3, or a disaggregated base station as discussed with respect to FIG. 2.

The communications device 1300 includes a processing system 1305 coupled to a transceiver 1365 (e.g., a transmitter and/or a receiver) and/or a network interface 1375. The transceiver 1365 is configured to transmit and receive signals for the communications device 1300 via an antenna 1370, such as the various signals as described herein. The network interface 1375 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1335. In various aspects, one or more processors 1310 may be representative of the one or more processors 308, as described with respect to FIG. 3. The one or more processors 1310 are coupled to the computer-readable medium/memory 1335 via a bus 1360. In certain aspects, the computer-readable medium/memory 1335 is configured to store instructions (e.g., computer-executable code), including code 1340-1355, that when executed by the one or more processors 1310, cause the one or more processors 1310 to perform the method 1100 described with respect to FIG. 11, or any aspect related to it, including any operations described in relation to FIG. 11. The computer-readable medium/memory 1335 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1335 stores code (e.g., executable instructions), including code for communicating 1340, code for sending 1345, code for refraining 1350, and code for obtaining 1355. Processing of the code 1340-1355 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1335, including circuitry for communicating 1315, circuitry for sending 1320, circuitry for refraining 1325, and circuitry for obtaining 1330. Processing with circuitry 1315-1330 may enable and cause the communications device 1300 to perform the method 1100 described with respect to FIG. 11, or any aspect related to it.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1365, antenna 1370, and/or network interface 1375 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1365, antenna 1370, and/or network interface 1375 of the communications device 1300 in FIG. 13, and/or one or more processors 1310 of the communications device 1300 in FIG. 13. For example, means for refraining of the method 1100 described with respect to FIG. 11, or any aspect related to it, may include the one or more transceivers 312, one or more antennas 314, and/or processing system 306 of the first network entity 300 or the second network entity 302 illustrated in FIG. 3, transceiver 1365, antenna 1370, and/or network interface 1375 of the communications device 1300 in FIG. 13, and/or one or more processors 1310 of the communications device 1300 in FIG. 13.

### Example Clauses

Implementation examples are described in the following numbered clauses:
Clause 1: A method for wireless communications by a first UE comprising: communicating via a first set of frequency resources allocated for uplink communications associated with a first cell; communicating via a second set of frequency resources allocated for downlink communications associated with the first cell; obtaining an indication of a measurement occasion associated with measurement of interference in the second set of frequency resources, wherein the measurement occasion is arranged in time relative to first signaling associated with a second cell; and monitoring for the interference during at least the measurement occasion.
Clause 2: The method of Clause 1, wherein: the first signaling includes synchronization signaling in the first set of frequency resources; and the interference includes second signaling associated with a second UE.
Clause 3: The method of Clause 2, wherein: communicating via the first set of frequency resources comprises communicating with a first network node via the first set of frequency resources; communicating via the second set of frequency resources comprises communicating with the first network node via the second set of frequency resources; the first signaling includes the synchronization signaling communicated via a second network node; and the second signaling includes a sounding reference signal transmitted by the second UE.
Clause 4: The method of any one of Clauses 1-3, wherein at least a first portion of the measurement occasion is offset in time from the first signaling, and the first portion of the measurement occasion includes a first time period during which second signaling is transmitted by a second UE.
Clause 5: The method of Clause 4, wherein: at least a second portion of the measurement occasion includes a second time period during which the first signaling is communicated; and the method further comprises refraining from communicating with the first cell during the at least the second portion of the measurement occasion.
Clause 6: The method of any one of Clauses 1-5, wherein obtaining the indication of the measurement occasion comprises obtaining the first signaling that indicates a portion of the measurement occasion is offset in time from the first signaling.
Clause 7: The method of any one of Clauses 1-6, further comprising obtaining a configuration that includes the indication of the measurement occasion, wherein the configuration further includes an indication that a sounding reference signal resource is associated with measurement of interference.
Clause 8: The method of Clause 7, wherein the configuration further includes an indication of one or more of: a bandwidth part in which the sounding reference signal resource is arranged, a subcarrier spacing associated with the sounding reference signal resource, or a center frequency associated with the sounding reference signal resource.
Clause 9: The method of any one of Clauses 1-8, wherein monitoring for the interference comprises monitoring for a sounding reference signal during at least the measurement occasion.
Clause 10: The method of Clause 9, wherein monitoring for the sounding reference signal comprises: obtaining a signal in the second set of frequency resources; and determining a measurement associated with the signal based on the signal and a pattern associated with the sounding reference signal.
Clause 11: The method of Clause 9 or 10, wherein a time gap is arranged between the first signaling and at least a portion of the measurement occasion during which the sounding reference signal is communicated, wherein the time gap includes a first duration associated with retuning a transceiver and a second duration associated with a timing advance.
Clause 12: The method of any one of Clauses 9-11, wherein the sounding reference signal occupies a same bandwidth as synchronization signaling.
Clause 13: The method of any one of Clauses 9-12, wherein the sounding reference signal is formed based on a sequence associated with measurement of cross-link interference between non-terrestrial communications and terrestrial communications.
Clause 14: The method of any one of Clauses 1-13, wherein: the first cell is associated with a non-terrestrial network node; and the second cell is associated with a terrestrial network node.
Clause 15: The method of any one of Clauses 1-14, wherein the interference includes cross-link interference between non-terrestrial communications and terrestrial communications.
Clause 16: The method of any one of Clauses 1-15, further comprising sending a measurement report that includes an indication of the interference in the second set of frequency resources.
Clause 17: The method of Clause 16, wherein the indication of the interference includes one or more of a received signal quality associated with a sounding reference signal or a received signal strength associated with the sounding reference signal.
Clause 18: A method for wireless communications by a first network node comprising: communicating via a first set of frequency resources allocated for uplink communications associated with a first cell; communicating via a second set of frequency resources allocated for downlink communications associated with the first cell; and sending an indication of a measurement occasion associated with measurement of interference in the second set of frequency resources, wherein the measurement occasion is arranged in time relative to first signaling associated with a second cell.
Clause 19: The method of Clause 18, wherein: the first signaling includes synchronization signaling in the first set of frequency resources; and the interference includes second signaling associated with a second UE.
Clause 20: The method of Clause 19, wherein: communicating via the first set of frequency resources comprises communicating with a first UE via the first set of frequency resources; communicating via the second set of frequency resources comprises communicating with the first UE via the second set of frequency resources; the first signaling includes the synchronization signaling associated with a second network node; and the second signaling includes a sounding reference signal associated with the second UE.
Clause 21: The method of any one of Clauses 18-20, wherein at least a first portion of the measurement occasion is offset in time from the first signaling, and the first portion of the measurement occasion includes a first time period during which second signaling is communicated.
Clause 22: The method of Clause 21, wherein: at least a second portion of the measurement occasion includes a second time period during which the first signaling is communicated; and the method further comprises refraining from communicating via the first cell during the at least the second portion of the measurement occasion.
Clause 23: The method of any one of Clauses 18-22, wherein sending the indication of the measurement occasion comprises sending the first signaling that indicates a portion of the measurement occasion is offset in time from the first signaling.
Clause 24: The method of any one of Clauses 18-23, further comprising sending a configuration that includes the indication of the measurement occasion, wherein the configuration further includes an indication that a sounding reference signal resource is associated with measurement of interference.
Clause 25: The method of Clause 24, wherein the configuration further includes an indication of one or more of: a bandwidth part in which the sounding reference signal resource is arranged, a subcarrier spacing associated with the sounding reference signal resource, or a center frequency associated with the sounding reference signal resource.
Clause 26: The method of any one of Clauses 18-25, wherein a time gap is arranged between the first signaling and at least a portion of the measurement occasion during which a sounding reference signal is communicated, wherein the time gap includes a first duration associated with retuning a transceiver and a second duration associated with a timing advance.
Clause 27: The method of Clause 26, wherein the sounding reference signal occupies a same bandwidth as synchronization signaling.
Clause 28: The method of Clause 26 or 27, wherein the sounding reference signal is based on a sequence associated with measurement of cross-link interference between non-terrestrial communications and terrestrial communications.
Clause 29: The method of any one of Clauses 18-28, wherein: the first cell is associated with a non-terrestrial network node; and the second cell is associated with a terrestrial network node.
Clause 30: The method of any one of Clauses 18-29, wherein the interference includes cross-link interference between non-terrestrial communications and terrestrial communications.
Clause 31: The method of any one of Clauses 18-30, further comprising obtaining a measurement report that includes an indication of the interference in the second set of frequency resources.
Clause 32: The method of Clause 31, wherein the indication of the interference includes one or more of a received signal quality associated with a sounding reference signal or a received signal strength associated with the sounding reference signal.
Clause 33: One or more apparatuses, comprising: one or more memories comprising executable instructions; and one or more processors configured to execute the executable instructions and cause the one or more apparatuses to perform a method in accordance with any one of Clauses 1-32.
Clause 34: One or more apparatuses configured for wireless communications, comprising: one or more memories; and one or more processors, coupled to the one or more memories, configured to cause the one or more apparatuses to perform a method in accordance with any one of Clauses 1-32.
Clause 35: One or more apparatuses configured for wireless communications, comprising: one or more memories; and one or more processors, coupled to the one or more memories, configured to perform a method in accordance with any one of Clauses 1-32.
Clause 36: One or more apparatuses, comprising means for performing a method in accordance with any one of Clauses 1-32.
Clause 37: One or more non-transitory computer-readable media comprising executable instructions that, when executed by one or more processors of one or more apparatuses, cause the one or more apparatuses to perform a method in accordance with any one of Clauses 1-32.
Clause 38: One or more computer program products embodied on one or more computer-readable storage media comprising code for performing a method in accordance with any one of Clauses 1-32.
Clause 39: One or more apparatuses configured for wireless communications, comprising: a processing system that includes one or more processors and one or more memories coupled with the one or more processors, the processing system configured to cause the one or more apparatuses to perform a method in accordance with any one of Clauses 1-32.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a first user equipment (UE) to:
communicate via a first set of frequency resources allocated for uplink communications associated with a first cell;
communicate via a second set of frequency resources allocated for downlink communications associated with the first cell;
obtain an indication of a measurement occasion associated with measurement of interference in the second set of frequency resources, wherein the measurement occasion is arranged in time relative to first signaling associated with a second cell; and
monitor for the interference during at least the measurement occasion.

2. The apparatus of claim 1, wherein:
the first signaling includes synchronization signaling in the first set of frequency resources; and
the interference includes second signaling associated with a second UE.

3. The apparatus of claim 2, wherein:
to cause the first UE to communicate via the first set of frequency resources, the processing system is configured to cause the first UE to communicate with a first network node via the first set of frequency resources;
to cause the first UE to communicate via the second set of frequency resources, the processing system is configured to cause the first UE to communicate with the first network node via the second set of frequency resources;
the first signaling includes the synchronization signaling communicated via a second network node; and
the second signaling includes a sounding reference signal transmitted by the second UE.

4. The apparatus of claim 1, wherein at least a first portion of the measurement occasion is offset in time from the first signaling, and the first portion of the measurement occasion includes a first time period during which second signaling is transmitted by a second UE.

5. The apparatus of claim 4, wherein:
at least a second portion of the measurement occasion includes a second time period during which the first signaling is communicated; and
the processing system is configured to cause the first UE to refrain from communicating with the first cell during the at least the second portion of the measurement occasion.

6. The apparatus of claim 1, wherein to cause the first UE to obtain the indication of the measurement occasion, the processing system is configured to cause the first UE to obtain the first signaling that indicates a portion of the measurement occasion is offset in time from the first signaling.

7. The apparatus of claim 1, wherein the processing system is configured to cause the first UE to obtain a configuration that includes the indication of the measurement occasion, wherein the configuration further includes an indication that a sounding reference signal resource is associated with measurement of interference.

8. The apparatus of claim 7, wherein the configuration further includes an indication of one or more of:
a bandwidth part in which the sounding reference signal resource is arranged,
a subcarrier spacing associated with the sounding reference signal resource, or
a center frequency associated with the sounding reference signal resource.

9. The apparatus of claim 1, wherein to cause the first UE to monitor for the interference, the processing system is configured to cause the first UE to monitor for a sounding reference signal during at least the measurement occasion.

10. The apparatus of claim 9, wherein to cause the first UE to monitor for the sounding reference signal, the processing system is configured to cause the first UE to:
obtain a signal in the second set of frequency resources; and
determine a measurement associated with the signal based on the signal and a pattern associated with the sounding reference signal.

11. The apparatus of claim 9, wherein a time gap is arranged between the first signaling and at least a portion of the measurement occasion during which the sounding reference signal is communicated, wherein the time gap includes a first duration associated with retuning a transceiver and a second duration associated with a timing advance.

12. The apparatus of claim 9, wherein the sounding reference signal occupies a same bandwidth as synchronization signaling.

13. The apparatus of claim 9, wherein the sounding reference signal is formed based on a sequence associated with measurement of cross-link interference between non-terrestrial communications and terrestrial communications.

14. The apparatus of claim 1, wherein:
the first cell is associated with a non-terrestrial network node; and
the second cell is associated with a terrestrial network node.

15. The apparatus of claim 1, wherein the interference includes cross-link interference between non-terrestrial communications and terrestrial communications.

16. The apparatus of claim 1, wherein the processing system is configured to cause the first UE to send a measurement report that includes an indication of the interference in the second set of frequency resources.

17. The apparatus of claim 16, wherein the indication of the interference includes one or more of a received signal quality associated with a sounding reference signal or a received signal strength associated with the sounding reference signal.

18. An apparatus for wireless communications, comprising a processing system that includes one or more processors and one or more memories coupled with the one or more processors, the processing system configured to cause a first network node to:
communicate via a first set of frequency resources allocated for uplink communications associated with a first cell;
communicate via a second set of frequency resources allocated for downlink communications associated with the first cell; and
send an indication of a measurement occasion associated with measurement of interference in the second set of frequency resources, wherein the measurement occasion is arranged in time relative to first signaling associated with a second cell.

19. The apparatus of claim 18, wherein the processing system is configured to cause the first network node to obtain a measurement report that includes an indication of the interference in the second set of frequency resources.

20. A method for wireless communications by a first user equipment (UE), comprising:
communicating via a first set of frequency resources allocated for uplink communications associated with a first cell;
communicating via a second set of frequency resources allocated for downlink communications associated with the first cell;
obtaining an indication of a measurement occasion associated with measurement of interference in the second set of frequency resources, wherein the measurement occasion is arranged in time relative to first signaling associated with a second cell; and
monitoring for the interference during at least the measurement occasion.
